(19) United States
(12) Patent Application Publication
(10) Pub. No.: US 2022/0384884 A1
(43) Pub. Date: Dec. 1, 2022

(54) POUCH TYPE LITHIUM SECONDARY BATTERY SEALER, SEALING METHOD AND POUCH TYPE LITHIUM SECONDARY BATTERY MANUFACTURED BY THE SAME

(71) Applicants: Hyundai Motor Company, Seoul (KR); Kia Corporation, Seoul (KR)

(72) Inventors: Sang Mok PARK, Gwangju-si (KR); Yoon Sung LEE, Suwon-si (KR); Yong Hoon KIM, Daejeon (KR); Jeong Wan YOO, Seoul (KR); Jun Ki RHEE, Suwon-si (KR); Ji Eun LEE, Hwaseong-si (KR)

(73) Assignees: Hyundai Motor Company, Seoul (KR); Kia Corporation, Seoul (KR)

(21) Appl. No.: 17/526,345

(22) Filed: Nov. 15, 2021

(30) Foreign Application Priority Data
May 31, 2021 (KR) 10-2021-0070370

(51) Int. Cl. H01M 50/184; H01M 50/105; H01M 50/119; H01M 50/124; H01M 50/178; H01M 50/536; H01M 10/058

(52) U.S. Cl. CPC H01M 50/184; H01M 50/105; H01M 50/119; H01M 50/124; H01M 50/178; H01M 50/536; H01M 10/058

(57) ABSTRACT

A pouch type lithium secondary battery may include an electrode assembly to which an electrode tab is attached; a pouch which includes an aluminum layer and a sealant layer and which encases the electrode assembly so that a portion of the electrode tab is exposed therefrom; a protrusion formed by sealant on a side of the pouch where the electrode tab is not exposed, in melting and flowing toward the electrode assembly then congealing to form a swelling on the pouch; and folds formed by bending a side of the pouch where the electrode tab is not exposed, wherein at least one of the folds includes the protrusion.

### CROSS-REFERENCE TO RELATED APPLICATION

The present application claims priority to Korean Patent Application No. 10-2021-0070370, filed May 31, 2021, the entire contents of which is incorporated herein for all purposes by this reference.

### BACKGROUND OF THE INVENTION

### Field of the Invention

The present invention relates to a method and apparatus of sealing a side of a pouch type lithium secondary battery, and a lithium secondary battery manufactured according to the same. Specifically, the purpose of the present invention is to minimize leakage of a sealant including a pouch toward an electrode assembly.

### Description of Related art

The types of external form of a lithium secondary battery include prismatic/cylindrical and pouch. In a pouch type, the external dimensions may be readily changed compared to a prismatic/cylindrical battery, which utilizes aluminum or steel. As the pouch is sealed using thermal bonding, venting occurs at relatively low pressure in the event of heat or gas generation, lowering the risk of explosion. Furthermore, the pouch type has less wasted space compared to a prismatic/cylindrical type and is lighter, giving the advantage of high energy density.

A pouch type lithium secondary battery is manufactured by inserting an electrode assembly into a pouch, then sealing the sides using thermal bonding. Here, the sealing occurs when the sealant forming the pouch (a material such as PP) is melted and then congeals. However, there is a problem that during thermal bonding, the sealant flows right and left due to pressing during thermal bonding, with some of the sealant flowing inward and the congealed sealant destroying an internal layer which prevents contact between an aluminum layer and an electrolyte, or acting as the cause of destruction of the aluminum layer to provide a cause for influx of moisture into the lithium secondary battery.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a sealing method which minimizes an amount of sealant which enters the inside of a battery cell, improving reliability of a pouch type lithium secondary battery in terms of electrochemical performance and stability.

To achieve the above-stated purpose, the pouch type lithium secondary battery of the present invention includes: an electrode assembly to which an electrode tab is attached; a pouch which includes an aluminum layer and a sealant layer and which encases the electrode assembly so that a portion of the electrode tab is exposed therefrom; a protrusion formed by sealant, on a side of the pouch where the electrode tab is not exposed, in melting and flowing toward the electrode assembly then congealing to form a swelling on the pouch; and folds formed by bending a side of the pouch where the electrode tab is not exposed, wherein at least one of the folds includes the protrusion.

The folds may include: a first folded surface which is formed by folding one end portion of the pouch remaining after encasing the electrode assembly; a second folded surface which is formed by bending one end portion of the first folded surface; a third folded surface which is formed by bending one end portion of the second folded surface; and a fourth folded surface which is formed by bending one end portion of the third folded surface.

The protrusion may be positioned on the second folded surface, where an angle formed by the first folded surface and the electrode assembly is 0 to 15 degrees, and an angle formed by the second folded surface and the electrode assembly is 45 to 120 degrees.

The protrusion may be positioned on the first folded surface, where an angle formed by the first folded surface and the electrode assembly is 15 to 45 degrees, and an angle formed by the second folded surface and the electrode assembly is 65 to 105 degrees.

The protrusion may be positioned on the second folded surface, where an angle formed by the second folded surface and the electrode assembly is 30 to 60 degrees.

A fastener attached to the pouch and the folds to fasten the pouch and the folds may be provided.

The sealer for sealing the pouch type lithium secondary battery includes an upper sealer on a bottom surface of which is formed with an inward-indented groove; a lower sealer on a top surface of which is formed with an inward-indented groove; and an inward-indented heat-dissipating groove is formed on side surfaces of the upper sealer and the lower sealer.

The grooves formed on the upper sealer and the lower sealer may be formed at positions facing each other.

The heat-dissipating groove may be formed at the side of the direction where the electrode assembly is positioned when the pouch type lithium secondary battery is sealed.

The method for sealing the pouch type lithium secondary battery includes a first sealing step, wherein the sides of the pouch of a pouch type lithium secondary battery are sealed by thermal bonding a first time; a second sealing step, wherein the sides of the pouch of the pouch type lithium secondary battery on which the first sealing step has been completed are sealed by thermal bonding a second time; and a folding step, wherein the sides of the pouch of the pouch type lithium secondary battery on which the second sealing step has been completed are folded.

In the first sealing step, the sealing by thermal bonding may be performed so that the pressure applied to the sides of the pouch is uniform, and in the second sealing step, the sealing by thermal bonding may be performed so that the farther away from the electrode assembly a side of the pouch is, the greater the pressure applied thereto.

In the folding step, the folding may be performed so that an angle formed by the electrode assembly and the first folded surface formed by folding one end portion of the pouch remaining after encasing the electrode assembly is 0 to 15 degrees, an angle formed by the electrode assembly and the second folded surface formed by folding one end portion of the first folded surface is 45 to 120 degrees, and the protrusion is positioned on the second folded surface.

In the folding step, the folding may be performed so that an angle formed by the electrode assembly and the first folded surface formed by folding one end portion of the pouch remaining after encasing the electrode assembly is 15 to 45 degrees, an angle formed by the electrode assembly and the second folded surface formed by folding one end portion of the first folded surface is 65 to 105 degrees, and the protrusion is positioned on the first folded surface.

In the folding step, a first folded surface may be formed by folding one end portion of the pouch remaining after encasing the electrode assembly, and an angle formed by the electrode assembly and the second folded surface formed by folding one end portion of the first folded surface may be 30 to 60 degrees, with the protrusion positioned on the second folded surface.

The pouch type lithium secondary battery manufactured according to various exemplary embodiments of the present invention minimizes the amount of sealant which enters the inside of the battery cell in the sealing step, improving reliability in terms of electrochemical performance and stability.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a lithium secondary battery sealed according to a conventional method for sealing a pouch type lithium secondary battery.

FIG. 2 is the pouch type lithium secondary battery according to various exemplary embodiments of the present invention.

FIG. 3 is the pouch type lithium secondary battery sealer according to various exemplary embodiments of the present invention.

FIG. 4 is a pouch side on which the second sealing step has been completed.

FIG. 5, FIG. 6, FIG. 7 and FIG. 8 show the folds of the pouch type lithium secondary battery according to various exemplary embodiments of the present invention.

FIG. 9 is a flow diagram of the sealing method for a pouch type lithium secondary battery according to various exemplary embodiments of the present invention.

FIG. 10 visually illustrates the first sealing step and the second sealing step.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

In the following, the solution to the above-stated purpose and problem will be described in detail with reference to the appended drawings. Meanwhile, in a case where detailed description of known art in the field of the present invention is not helpful to understanding essential parts of the present invention, such description will be omitted. The technical idea of the present invention is not limited hereto, and the present invention may be conducted in various modified forms by a person having ordinary skill in the art.

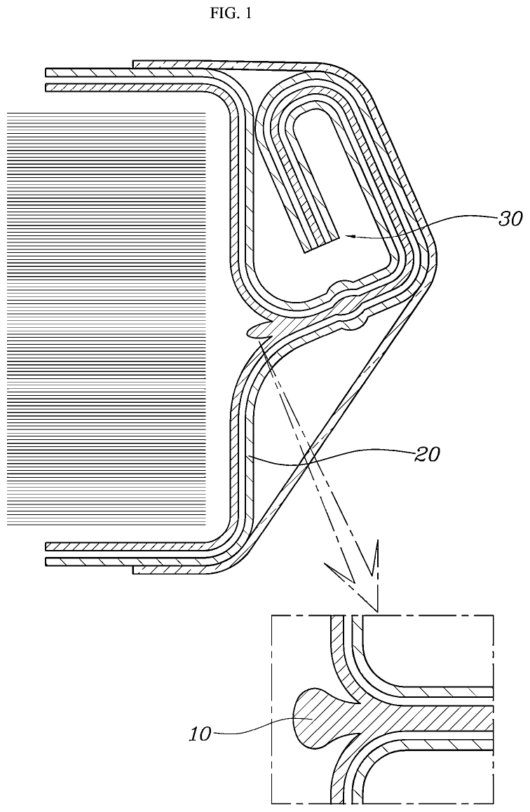

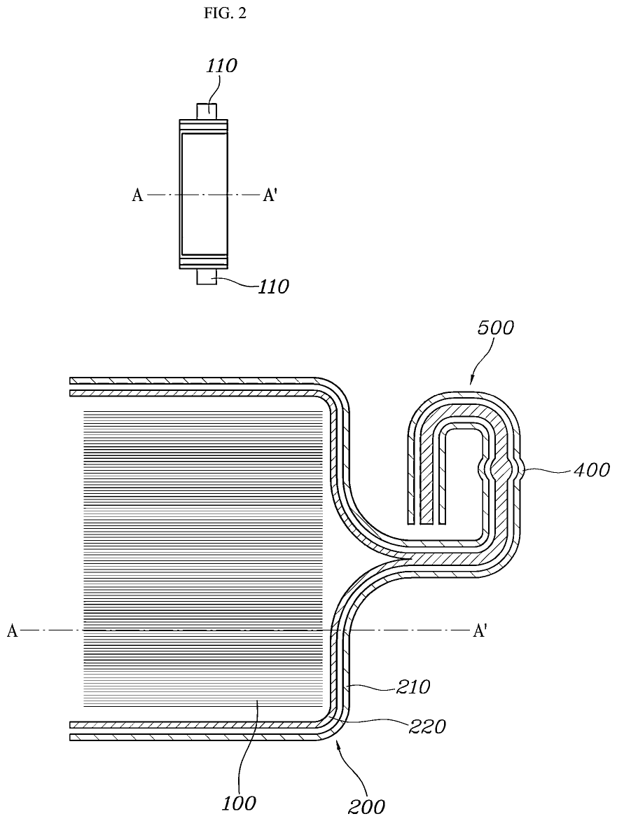

FIG. 1 is a lithium secondary battery sealed according to a conventional method for sealing a pouch type lithium secondary battery. Due to high pressure locally applied during sealing by thermal bonding of a pouch type lithium secondary battery, the sealant 10 may leak into and congeal inside a battery cell in an internal layer of the pouch. In such case, the congealed sealant causes problems in the ensuing steps. In a process of folding the sides 30 of a sealed pouch, the congealed sealant may act as a lever to form fine cracks in the pouch, with the electrolyte coming into contact with an aluminum layer 20 through these pouches and becoming a cause for defects in the lithium secondary battery. Furthermore, if cracks occur in the aluminum layer 20 of the pouch, outside moisture enters the battery cell, resulting in gas generation and electrolyte leakage.

Accordingly, the electrochemical properties of the lithium secondary battery deteriorate, and safety issues are caused. A means for improving the reliability of a pouch type lithium secondary battery may be to prevent leakage of sealant into the battery cell, and to appropriately fold the sides of the sealed pouch.

To achieve the above-stated purpose, the pouch type lithium secondary battery of the present invention includes: an electrode assembly 100 to which an electrode tab 110 is attached; a pouch 200 which includes an aluminum layer 210 and a sealant layer 220 and which encases the electrode assembly 100 in a manner where portion of the electrode tab 110 is exposed; a protrusion 400 formed by sealant, on a side of the pouch where the electrode tab 110 is not exposed, in melting and flowing toward the electrode assembly 100 then congealing to form a swelling on the pouch 200; and folds 500 formed by bending a side of the pouch where the electrode tab 110 is not exposed, where at least one of the folds includes a protrusion 400.

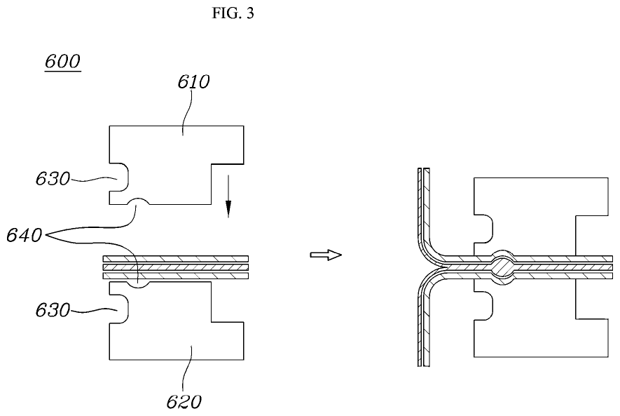

FIG. 2 shows the pouch type lithium secondary battery according to various exemplary embodiments of the present invention. The pouch type lithium secondary battery according to various exemplary embodiments of the present invention is, wherein it is able to minimize the leakage of sealant into a battery cell toward the electrode assembly 100. As for the method for minimizing the leakage of sealant, the pouch type lithium secondary battery sealer 600 shown in FIG. 3 is used to seal the sides of the pouch through thermal bonding.

The sealer 600 for sealing the pouch type lithium secondary battery includes an upper sealer 610 on the bottom surface of which is formed to an inward-indented groove 640; a lower sealer 620 on a top surface of which is formed with an inward-indented groove 640; and an inward-indented heat-dissipating groove 630 formed on the side surfaces of the upper sealer 610 and the lower sealer 620.

Referring to FIG. 3, the grooves 640 formed on the upper sealer 610 and the lower sealer 620 may be formed at positions facing each other, and the heat-dissipating groove 630 may be formed at the side of the direction where the electrode assembly 100 is positioned when the pouch type lithium secondary battery is sealed.

A side of the pouch 200 is loaded onto the upper face of the lower sealer 620, onto which the upper sealer 610 descends. The lower sealer 620 and the upper sealer 610 are thermally bonded, causing the sealant of the sealant layer 220 to melt, then congeal to form a seal. Here, a groove 640 may be formed on opposite positions on the upper sealer 610 and the lower sealer 620, so that sealant flowing out toward the electrode assembly 100 enters the space formed by the groove 640 and congeals therein to form a protrusion 400. That is, the grooves 640 are an element for forming a protrusion 400 to absorb sealant which flows out toward the electrode assembly 100.

To minimize the amount of sealer flowing out toward the electrode assembly 100, it is necessary to minimize the movement of sealant positioned nearby the electrode assembly 100. Accordingly, a heat-dissipating groove 630 is provided. The heat-dissipating groove 630 is an element for dissipating localized thermal energy from the heated upper sealer 610 and lower sealer 620 so that the temperature in the areas around the heat-dissipating groove 630 are lower than that of other areas, slowing the melting of sealant and minimizing the flow of sealant positioned nearby the electrode assembly 100. That is, when the sides of a pouch are compressed by the upper sealer 610 and the lower sealer 620, the area around the heat-dissipating groove 630 has a relatively low temperature, resulting in the least relative flow of sealant. This blocks the flow of sealant from outside the heat-dissipating groove toward the electrode assembly 100, preventing the leak of sealant into the battery cell.

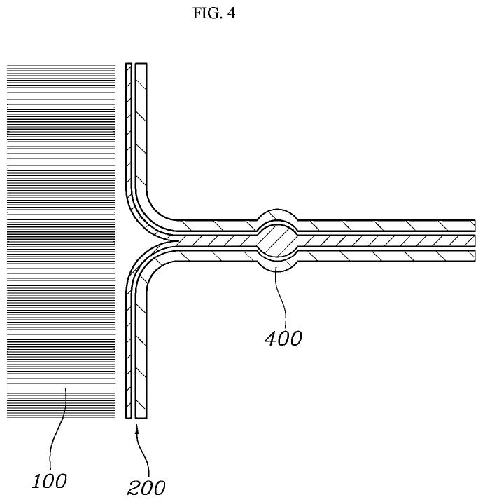

Meanwhile, a thermally bonded pouch side has the shape shown in FIG. 4. Sealing of the lithium secondary battery is completed by folding the thermally bonded pouch sides. The folded pouch sides form folds 500, where the folds 500 may include: a first folded surface 510 which is formed by folding one end portion of the pouch remaining after encasing the electrode assembly; a second folded surface 520 which is formed by bending one end portion of the first folded surface 510; a third folded surface 530 which is formed by bending one end portion of the second folded surface 520; and a fourth folded surface 540 which is formed by bending one end portion of the third folded surface 530.

The protrusion 400 may be positioned on the first folded surface 510 or on the second folded surface 520. Depending on an angle formed by the folded surface on which the protrusion 400 is positioned and the first folded surface 510, and an angle formed by the second folded surface 520 and the electrode assembly 100, various different embodiments are possible.

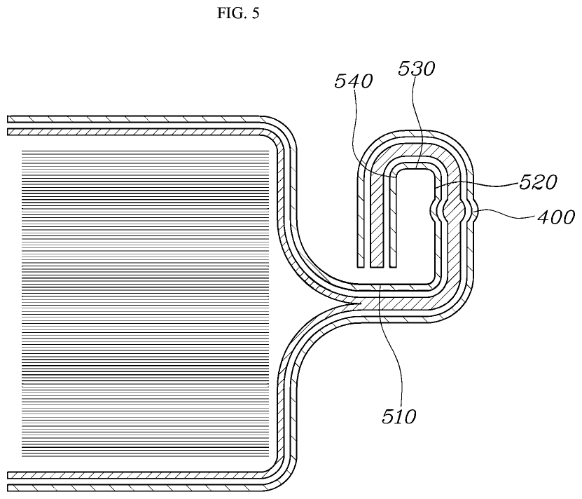

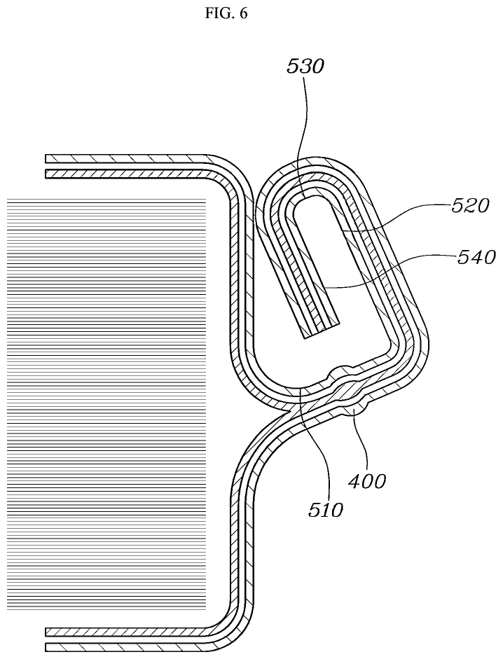

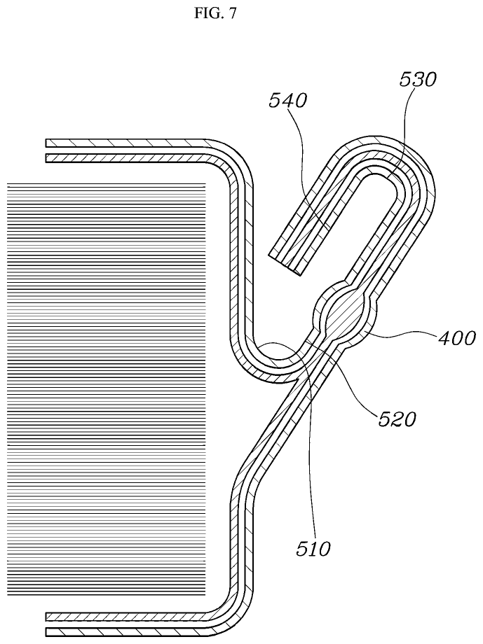

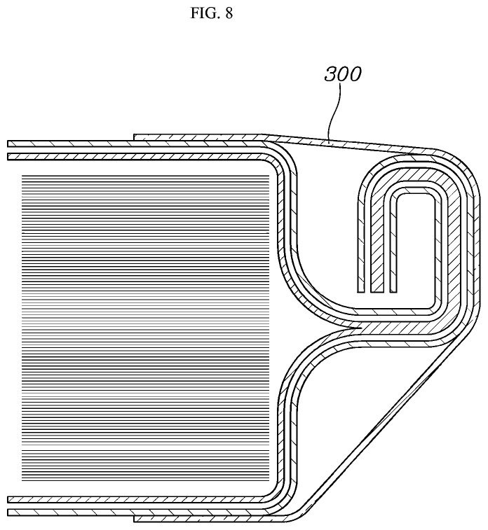

An exemplary embodiment of the present invention is shown in FIG. 5, where the protrusion 400 is positioned on the second folded surface 520, with an angle formed by the first folded surface 510 and the electrode assembly 100 is 0 to 15 degrees, and an angle formed by the second folded surface 520 and the electrode assembly 100 is 45 to 120 degrees.

Various exemplary embodiments are shown in FIG. 6, where the protrusion 400 is positioned on the first folded surface 510, with an angle formed by the first folded surface 510 and the electrode assembly 100 is 15 to 45 degrees, and an angle formed by the second folded surface 520 and the electrode assembly 100 is 65 to 105 degrees.

Various exemplary embodiments are shown in FIG. 7, where the protrusion 400 is positioned on the second folded surface 520, and an angle formed by the second folded surface 520 and the electrode assembly 100 may be 30 to 60 degrees.

The position of the protrusion 400, and the angles formed by the first folded surface 510 and the second folded surface 520 with the electrode assembly 100 are not limited to the above, and may vary within a scope which is self-evident to a person having ordinary skill in the art.

Meanwhile, referring to FIG. 8, a fastener 300 which is attached to the pouch 200 and folds to fasten the pouch and the folds may be provided. The fastener 300 is attached so that a certain tension is applied to the pouch 200 and folds 500, so that the folds 500 do not become unfurled.

Meanwhile, the method for sealing the pouch type lithium secondary battery includes a first sealing step S100, wherein the sides of the pouch of a pouch type lithium secondary battery are sealed by thermal bonding a first time; a second sealing step S200, wherein the sides of the pouch of the pouch type lithium secondary battery on which the first sealing step S100 has been completed are sealed by thermal bonding a second time; and a folding step S300, wherein the sides of the pouch of the pouch type lithium secondary battery on which the second sealing step S200 has been completed are folded.

In the first sealing step S100, the sealing by thermal bonding may be performed so that the pressure applied to the sides of the pouch is uniform, and in the second sealing step S200, the sealing by thermal bonding may be performed so that the farther away from the electrode assembly 100 a side of the pouch is, the greater the pressure applied thereto.

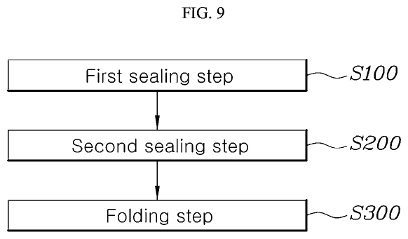

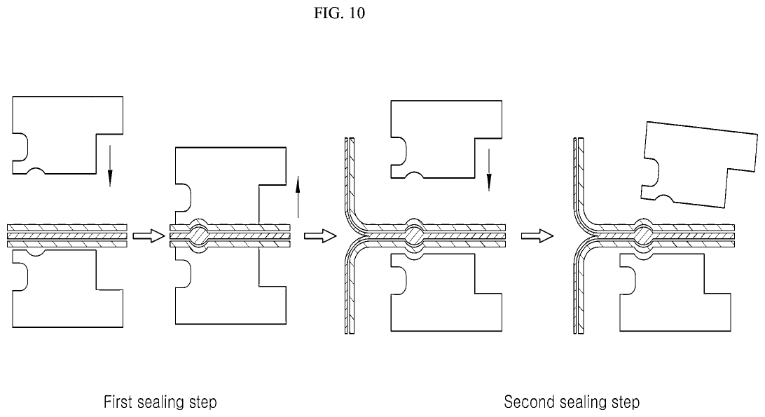

Referring to FIG. 9 through FIG. 10, in the first sealing step S100, sealing may be performed with the sealers level so that uniform pressure is applied to the pouch sides, and in the second sealing step S200, sealing may be performed with the descending upper sealer 610 tilted so that greater force is applied to the pouch sides as distance from the electrode assembly 100 increases.

The pouch side may be sealed a first time through the first sealing step S100, and in the portion of the pouch side above which the heat-dissipating groove 630 is positioned, the relatively lower temperature minimizes the flow of sealant, while the fluidity of the sealant increases as distance from the electrode assembly 100 increases. The increased-fluidity sealant flows toward the electrode assembly 100 and congeals to form a protrusion 400.

The outside seal may be made more robust by applying higher pressure moving out toward the edge portion of the pouch sides in the second sealing step S200, and this minimizes the leakage of sealant into the battery cell.

Meanwhile, in the folding step S300, the folding may be performed so that an angle formed by the electrode assembly and the first folded surface formed by folding one end portion of the pouch remaining after encasing the electrode assembly is 0 to 15 degrees, an angle formed by the electrode assembly and the second folded surface formed by folding one end portion of the first folded surface is 45 to 120 degrees, and the protrusion is positioned on the second folded surface.

Furthermore, in the folding step, the folding may be performed so that an angle formed by the electrode assembly and the first folded surface formed by folding one end portion of the pouch remaining after encasing the electrode assembly is 15 to 45 degrees, an angle formed by the electrode assembly and the second folded surface formed by folding one end portion of the first folded surface is 65 to 105 degrees, and the protrusion is positioned on the first folded surface.

Furthermore, in the folding step, a first folded surface may be formed by folding one end portion of the pouch remaining after encasing the electrode assembly, and an angle formed by the electrode assembly and the second folded surface formed by folding one end portion of the first folded surface may be 30 to 60 degrees, with the protrusion positioned on the second folded surface.

Through the above-described lithium secondary battery sealer and method for sealing a pouch type lithium secondary battery, flow of sealant into a battery cell may be minimized to prevent contact between an electrolyte and an aluminum layer, minimizing potential defects and further allowing for manufacture of a lithium secondary battery having high reliability in terms of electrochemical characteristics and stability.

Furthermore, by folding the pouch sides, the volume of the folds may be minimized, helping to improve the energy density of a lithium secondary battery.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A pouch type lithium secondary battery comprising:
an electrode assembly to which an electrode tab is attached;
a pouch which includes an aluminum layer and a sealant layer and encases the electrode assembly so that a portion of the electrode tab is exposed therefrom;
a protrusion formed by sealant, on a side of the pouch where the electrode tab is not exposed, in melting and flowing toward the electrode assembly then congealing to form a swelling on the pouch; and
folds formed by bending a side of the pouch where the electrode tab is not exposed, wherein at least one of the folds includes the protrusion.

2. The pouch type lithium secondary battery of claim 1, wherein the folds include:
a first folded surface which is formed by folding one end portion of the pouch remaining after encasing the electrode assembly;
a second folded surface which is formed by bending one end portion of the first folded surface;
a third folded surface which is formed by bending one end portion of the second folded surface; and
a fourth folded surface which is formed by bending one end portion of the third folded surface.

3. The pouch type lithium secondary battery of claim 2,
wherein the protrusion is positioned on the second folded surface,
wherein an angle formed by the first folded surface and the electrode assembly is 0 to 15 degrees, and
wherein an angle formed by the second folded surface and the electrode assembly is 45 to 120 degrees.

4. The pouch type lithium secondary battery of claim 2,
wherein the protrusion is positioned on the first folded surface,
wherein an angle formed by the first folded surface and the electrode assembly is 15 to 45 degrees, and
wherein an angle formed by the second folded surface and the electrode assembly is 65 to 105 degrees.

5. The pouch type lithium secondary battery of claim 2,
wherein the protrusion is positioned on the first folded surface, and
wherein an angle formed by the second folded surface and the electrode assembly is 30 to 60 degrees.

6. The pouch type lithium secondary battery of claim 1, further including a fastener attached to the pouch and the folds to fasten the pouch to the folds.

7. A sealer for sealing the pouch type lithium secondary battery of claim 1, the sealer including:
an upper sealer on a bottom surface of which is formed with an inward-indented groove; and
a lower sealer on a top surface of which is formed with an inward-indented groove,
wherein an inward-indented heat-dissipating groove is formed on side surfaces of the upper sealer and the lower sealer.

8. The sealer of claim 7, wherein the inward-indented grooves formed on the upper sealer and the lower sealer are formed at positions facing each other.

9. The sealer of claim 7, wherein the inward-indented heat-dissipating groove is formed in a direction where the electrode assembly is positioned when the pouch type lithium secondary battery is sealed.

10. A method for sealing the pouch type lithium secondary battery using the sealer of claim 7, the method comprising:
a first sealing step of sealing the side of the pouch of the pouch type lithium secondary battery by thermal bonding a first time;
a second sealing step of sealing the side of the pouch of the pouch type lithium secondary battery on which the first sealing step has been completed, by thermal bonding a second time; and
a folding step of folding the side of the pouch of the pouch type lithium secondary battery on which the second sealing step has been completed.

11. The method of claim 10, wherein
in the first sealing step, the sealing by thermal bonding is performed so that a pressure applied to the side of the pouch is uniform; and
in the second sealing step, the sealing by thermal bonding is performed so that the farther away from the electrode assembly the side of the pouch is, the greater the pressure applied thereto.

12. The method of claim 11, wherein, in the second sealing step, the sealing by thermal bonding is performed with the descending upper sealer tilted away from the electrode assembly so that greater force is applied to the side of the pouch as distance from the electrode assembly increases.

13. The method of claim 10, wherein
in the folding step, the folding is performed so that an angle formed by the electrode assembly and a first folded surface formed by folding one end portion of the pouch remaining after encasing the electrode assembly is 0 to 15 degrees;
an angle formed by the electrode assembly and a second folded surface formed by folding one end portion of the first folded surface is 45 to 120 degrees; and
the protrusion is positioned on the second folded surface.

14. The method of claim 10, wherein in the folding step, the folding is performed so that an angle formed by the electrode assembly and a first folded surface formed by folding one end portion of the pouch remaining after encasing the electrode assembly is 15 to 45 degrees;
an angle formed by the electrode assembly and a second folded surface formed by folding one end portion of the first folded surface is 65 to 105 degrees; and
the protrusion is positioned on the first folded surface.

15. The method of claim 10, wherein
in the folding step, a first folded surface is formed by folding one end portion of the pouch remaining after encasing the electrode assembly;
an angle formed by the electrode assembly and a second folded surface formed by folding one end portion of the first folded surface is 30 to 60 degrees; and
the protrusion is positioned on the first folded surface.
